(19) United States
(12) Patent Application Publication
(10) Pub. No.: US 2001/0007114 A1
(43) Pub. Date: Jul. 5, 2001

(54) Control apparatus and control method

(76) Inventor: Tsuyoshi Iizuka, Tokyo (JP)

Correspondence Address: BIRCH, STEWART, KOLASCH & BIRCH, LLP, P.O. BOX 747, FALLS CHURCH, VA, 22040-0747, US

(21) Appl. No.: 09/727,773

(22) Filed: Dec. 4, 2000

(30) Foreign Application Priority Data
Dec. 28, 1999 (JP) HEI 11-373439

(51) Int. Cl. G06F 13/00

(52) U.S. Cl. 710/100

(57) ABSTRACT

The present invention aims to provide a control apparatus for controlling a hardware to be controlled such as a hardware for data transfer, especially a control apparatus for controlling at a high speed and steadily. A task identifying circuit connected to an address/control bus outputs a signal of a task identifier specified by at least a part of a received address. A write controlling unit outputs a write control signal based on the received address and a write request, and a task register stores the task identifier at a timing of the write control signal. A command register inputs a command from a data bus, and a data transferring circuit transfers the data based on the data stored in the register.

### BACKGROUND OF THE INVENTION

1. Field of the invention

The present invention relates to, for example, a control apparatus controlling a hardware to be controlled such as a hardware employed for data transfer, in particular, to a control apparatus capable to control speedily and steadily.

2. Description of the Related Art

FIG. 14 shows a system organization in case of send data between computer systems according to the conventional art.

In the figure, a reference numeral 1 shows a computer system send data. A reference numeral 2 shows another computer system send data mutually with the computer system 1. 3 shows a data transfer channel transferring data between the computer systems 1 and 2.

The computer system 1 includes elements denoted by reference numerals 10 through 14. A CPU (central processing unit) 10 performs an operation, control and so on. A memory 11 stores instruction and data required for the operation executed by the CPU 10. A hardware 12 for data transfer performs data transfer. The hardware 12 for data transfer is controlled by the CPU 10. A reference numeral 13 shows an address/control bus connecting to the CPU 10, the memory 11 and the hardware 12 for data transfer. The address/control bus transmits an address and a control signal. 14 shows a data bus connecting to the CPU 10, the memory 11 and the hardware 12 for data transfer. The data bus 14 transfers data.

The computer system 2 includes elements denoted by reference numerals 15 through 19. A CPU (central processing unit) 15 performs an operation, control and so on. A memory 16 stores instruction and data required for the operation executed by the CPU 15. A hardware 17 for data transfer performs data transfer. The hardware 17 for data transfer is controlled by the CPU 15. A reference numeral 18 shows an address/control bus connecting to the CPU 15, the memory 16 and the hardware 17 for data transfer. The address/control bus transmits an address and a control signal. 19 shows a data bus connecting to the CPU 15, the memory 16 and the hardware 17 for data transfer. The data bus 19 transfers data.

An operation will be explained in the following. The CPU 10 reads the instruction and the data stored in the memory 11. At this time, the CPU 10 reads the instruction and the data from the memory 11 through the address/control bus 13 and the data bus 14. The CPU 10 operates according to the instruction and the data read from the memory.

Here, it is assumed that the computer system 1 transfers the data to the computer system 2 by controlling the hardware 12 for data transfer. The CPU 10 transfers controlling information to the hardware 12 for data transfer. The controlling information is data required for data transfer. The CPU 10 transfers the data to the hardware 12 for data transfer through the address/control bus 13 and the data bus 14.

The hardware 12 for data transfer is operated according to the controlling information supplied from the CPU 10. First, the hardware 12 for data transfer reads the send data. At this time, the hardware 12 for data transfer reads the send data from the memory 11 using the address/control bus 13 and the data bus 14. Then, the hardware 12 for data transfer outputs the send data and transferring information required for the data transfer to the transfer channel 3.

A case will be explained in which the computer system 2 receives the data output by the hardware 12 for data transfer of the computer system 1 to the transfer channel 3. The hardware 17 for data transfer receives the send data and the transferring information supplied from the data transfer channel 3. The hardware 17 for data transfer writes the send data received in the memory 16 through the address/control bus 18 and the data bus 19.

When all of the data transferred from the computer system 1 has been written in the memory 16, the hardware 17 for data transfer informs the CPU 15 of completion of receiving the send data. The hardware 17 for data transfer can inform the CPU 15 by any way.

As has been described, the data transfer from the computer system 1 to the computer system 2 has been completed.

Next, a conventional method for controlling the hardware 12 for data transfer will be explained. FIG. 15 shows an organization of the conventional hardware for data transfer.

FIG. 15 is shown in reference to the computer system taught by “Computer Organization & Design”, published by Nikkei BP Co. Here, an example is explained in case of the hardware for data transfer, however, the operation will be the same in case of a hardware to be controlled having a function other than transferring the data. According to this control method, controlling information and attribute information is set for the hardware to be controlled. In this example, controlling information is a transfer command and the attribute information is a task identifier.

In the figure, reference numerals 10 through 14 are the same as ones in FIG. 14. 20 shows a command register in which transfer command is set. The command register 20 is included in the hardware 12 for data transfer. 21 shows a task register for setting the task identifier. The task register 21 is also included in the hardware 12 for data transfer. A write control circuit 22 controls write operation to the command register 20 and the task register 21. The write control circuit 22 is included in the hardware 12 for data transfer. 23 is a write control signal issued by the write control circuit 22 for controlling write operation to the command register 20. 24 is a write control signal issued by the write control circuit 22 for controlling write operation to the task register 21.

In the following, the operation of the hardware 12 for data transfer will be described. The CPU 10 controls the hardware 12 for data transfer by setting the task identifier and the transfer command in the hardware 12 for data transfer.

First, the setting operation of the task identifier by the CPU 10 is explained. The CPU 10 outputs an address of the task register 21 and a write request to the address/control bus 13. Simultaneously, the CPU 10 also outputs the task identifier to be set to the data bus 14.

The write control circuit 22 detects the above address and the write request. By this detection, the write control circuit 22 recognizes a write cycle to the task register 21. The write control circuit 22 generates the write control signal 24 for indicating the write operation to the task register 21.

The task register 21 receives the task identifier on the data bus 14 at the timing of receiving the write control signal 24, and the task register 21 holds the task identifier. By this operation, the task identifier supplied from the CPU 10 is set in the task register 21.

Next, the setting operation of the transfer command in the command register 20 by the CPU 10 is explained. The CPU 10 outputs a write request and an address of the command register 20 to the address/control bus 13. Simultaneously, the CPU 10 also outputs the transfer command to be set to the data bus 14.

The write control circuit 22 detects the above address and the write request. By this detection, the write control circuit 22 recognizes a write cycle to the command register 20. The write control circuit 22 generates the write control signal 23 for indicating the write operation to the command register 20.

The command register 20 receives the transfer command on the data bus 14 at the timing of receiving the write control signal 23, and the command register 20 holds the task identifier. By this operation, the transfer command supplied from the CPU 10 is set in the command register 20.

When the transfer command is set in the command register 20 by the above procedure, the hardware 12 for data transfer transfers the data according to the transfer command. A circuit performing the transfer of data is not shown in the figure. This circuit is connected, at least, to the task register 21, the command register 20 and the data transfer channel 3.

This circuit outputs the above task identifier set in the task register 21 to the data transfer channel 3 based on the transfer command. Then, the circuit specifies an address of the send data corresponding to the task identifier. The circuit outputs the address of the send data and a read request to the address/control bus 13. By detecting the address and the read request, the memory 11 recognizes a read cycle to the memory 11. The memory 11 outputs the send data stored in the address within the memory 11 to the data bus 14. The hardware 12 for data transfer receives the send data by this circuit and transfers the data to the data transfer channel 3. Through the above operation, the data is transferred from the computer system 1 to the computer system 2.

In the above control system of data transfer, a fault of the task program of the computer system 1 may cause to set an improper task identifier in the hardware 12 for data transfer. The task program is constructed by the user and the user may construct the task program for outputting an improper task identifier to the data bus 14. In such a case, the hardware 12 for data transfer may operate improperly. This problem is not limited to a case where the task identifier is set, but also a case where another attribute information is set.

To avoid such a malfunction, it is considered that the task instructs an operating system to set the task identifier. In this way, the operating system sets the task identifier to be controlled by the operating system itself, which can avoid to set the improper task identifier in the hardware 12 for data transfer.

FIG. 16 shows an operation of conventional software. The attribute information (such as a task identifier) and control information is set by the operating system operating as shown in the figure.

A reference numeral 50 shows an address map. 51 shows a memory space for accessing the memory 11. 52 shows a hardware access space for accessing the hardware 12 for data transfer. 53 shows a command register space for accessing the command register 20. 56 shows a task register space for accessing the task register 21. 60 through 62 are tasks. 63 shows an operating system.

The software operating on the CPU 10 can access the memory 11 via the memory space 51. Similarly, the software can access the command register 20 via the command register space 53 and access the task register 21 via the task register space 56.

Each of the tasks 60 through 62 issue instructions to the operating system 63. The operating system 63 accesses the hardware access space 52 (namely, the command register space 53 and the task register space 56) based on the instruction.

The transfer performance of the conventional data transfer control system is inferior in send data to the hardware to be controlled (e.g., the hardware for data transfer) because the attribute information and the control information is respectively transferred.

Further, in case where the task directly accesses to the hardware access space, it is impossible to prevent malfunction caused by the error of the task program.

Further, in case where the attribute information and the control information is set through the operating system, the operating system have to operate each time of setting such information. Accordingly, there is a lot of delay generated in a series of control process because of an overhead process of the operating system.

### SUMMARY OF THE INVENTION

The present invention is provided to solve the above problem and the invention aims to control the hardware to be controlled at a high speed and properly. For example, in case of controlling the hardware for data transfer, the high-speed and correct control can enormously increase the performance and the secrecy of the data transfer between the computer systems. Further, in case of controlling another kind of hardware to be controlled, the high-speed and correct control can sufficiently accomplish the object of the control, make the operation of the computer system comfortable, and spread the use of the computer system, which remarkably improve the practicability of the computer system.

According to the present invention, a control apparatus connected to a bus communicating a physical address, control information used for controlling, and a write request includes:

(1) an attribute information identifying circuit connected to at least a part of the bus and including plural attribute entries, each of which stores attribute information, wherein

the attribute information identifying circuit receives at least a part of the physical address, specifies one attribute entry from the plural attribute entries based on the at least a part of the physical address received, and outputs the attribute information stored in the one attribute entry specified above;

(2) a write control circuit connected to the bus, wherein

the write control circuit receives the physical address and the write request from the bus, and outputs a write control signal when a write instruction is detected based on the physical address and the write request received; and

(3) a unit to be controlled connected to the bus, the write control circuit and the attribute information identifying circuit, wherein

the unit to be controlled inputs the write control signal, when the write control signal is input, the unit to be controlled receives the control information from the bus and inputs the attribute information output from the attribute information identifying circuit, and

the unit to be controlled is controlled based on the control information received, and operates based on the attribute information input.

According to another aspect of the invention, a control apparatus connected to a bus communicating a physical address, control information used for controlling, and a write request includes:

(1) a controlling unit having a task program memory, an OS program memory, and a processing apparatus, wherein:

the task program memory is connected to the bus and stores plural task programs, each of which operates as a task;

the OS program memory is connected to the bus and stores an operating system program which manages plural access spaces for accessing an identical object to be controlled and operates as an operating system (OS) for making correspondence of the task with one or plural of the plural access spaces; and

the processing apparatus is connected to the bus and loads the operating system program, activates the operating system, loads the plural task programs, activates the task corresponding to the one or plural access spaces by the operating system, and transmits the physical address, the control information and the write request by an operation of the task;

(2) an attribute information identifying circuit connected to at least a part of the bus, wherein

the attribute information identifying circuit receives at least a part of the physical address from the bus, and outputs the attribute information specified by at least a part of the physical address received;

(3) a write control circuit connected to the bus, wherein

the write control circuit receives the physical address and the write request from the bus, and outputs a write control signal when a write instruction is detected based on the physical address and the write request received; and

(4) a unit to be controlled, which is the identical object to be controlled, connected to the bus, the write control circuit and the attribute information identifying circuit, wherein

the unit to be controlled inputs the write control signal, receives the control information from the bus when the write control signal is input, inputs the attribute information output from the attribute information identifying circuit, and

the unit to be controlled is controlled by the control information received and operates based on the attribute information input.

According to the present invention, a method for controlling a control apparatus connected to a bus communicating a physical address, control information used for control, and a write request and having

an attribute information identifying circuit connected to at least a part of the bus and including plural attribute entries, each of which stores attribute information,

a write control circuit connected to the bus, and

a unit to be controlled connected to the bus, the write control circuit, and the attribute information identifying circuit, the method includes:

(1) receiving at least a part of the physical address from the bus, specifying one attribute entry from the plural attribute entries based on the at least a part of the physical address received, and outputting the attribute information stored in the one attribute entry specified above by the attribute information identifying circuit;

(2) receiving the physical address and the write request from the bus, and outputting a write control signal when a write instruction is detected based on the physical address and the write request received by the write control circuit; and

(3) inputting the write control signal, when the write control signal is input, receiving the control information from the bus, and inputting the attribute information output from the attribute information identifying circuit, and

being controlled based on the control information received, and operating based on the attribute information input by the unit to be controlled.

According to another aspect of the invention, a method for controlling a control apparatus connected to a bus communicating a physical address, control information used for controlling, and a write request having:

a task program memory connected to the bus and storing plural task programs, each of which operates as a task;

an OS program memory connected to the bus and storing an operating system program which manages plural access spaces for accessing an identical object to be controlled and operates as an operating system (OS) for making a correspondence of the task with one or plural of the plural access spaces;

a processing apparatus connected to the bus;

an attribute information identifying circuit connected to at least a part of the bus;

a write control circuit connected to the bus; and

a unit to be controlled, which is the identical object to be controlled, connected to the bus, the write control circuit and the attribute information identifying circuit, the method includes:

(1) loading the operating system program, activating the operating system, loading the plural task programs, activating the task corresponding to the one or plural of the plural access spaces by the operating system, and transferring the physical address, the control information and the write request by the processing apparatus;

(2) receiving at least a part of the physical address from the bus, and outputting the attribute information specified by at least a part of the physical address received by the attribute information identifying circuit;

(3) receiving the physical address and the write request from the bus, and outputting a write control signal when a write instruction is detected based on the physical address and the write request by the write control circuit received; and

(4) inputting the write control signal, receiving the control information from the bus when the write control signal is input, and inputting the attribute information output from the attribute information identifying circuit, and

being controlled by the control information received and operating based on the attribute information input by the unit to be controlled.

These and other objects and features of the invention will be better understood by reference to the detailed description which follows taken together with the drawings in which like elements are referred to by like designations throughout the several views.

### BRIEF DESCRIPTION OF THE DRAWINGS

In the drawings,

FIG. 1 shows an organization of a control apparatus for data transfer according to the first embodiment of the invention;

FIG. 2 shows an operation of software according to the first embodiment;

FIG. 3 shows an organization of a control apparatus for data transfer according to the second embodiment;

FIG. 4 shows an organization of a control apparatus for data transfer according to the third embodiment;

FIG. 5 shows an operation of software according to the fourth embodiment;

FIG. 6 shows an operation of software according to the fifth embodiment;

FIG. 7 shows an operation of software according to the sixth embodiment;

FIG. 8 shows an organization of a circuit embodying a protecting function of a task space;

FIG. 9 shows an organization of a control apparatus for data transfer according to the seventh embodiment;

FIG. 10 shows an organization of a control apparatus for data transfer according to the eighth embodiment;

FIG. 11 shows an organization of a control apparatus for data transfer according to the ninth embodiment;

FIG. 12 shows an organization of a control apparatus for data transfer according to the tenth embodiment;

FIG. 13 shows an organization of a control apparatus for data transfer according to the eleventh embodiment;

FIG. 14 shows a system organization in case of the conventional data transfer between the computer systems;

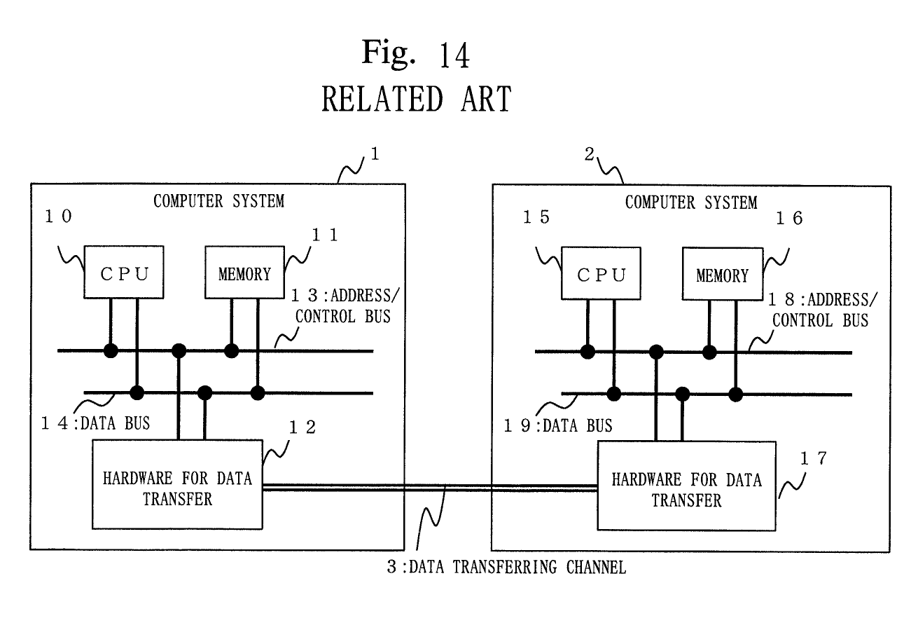

FIG. 15 shows an organization of the conventional hardware for data transfer;

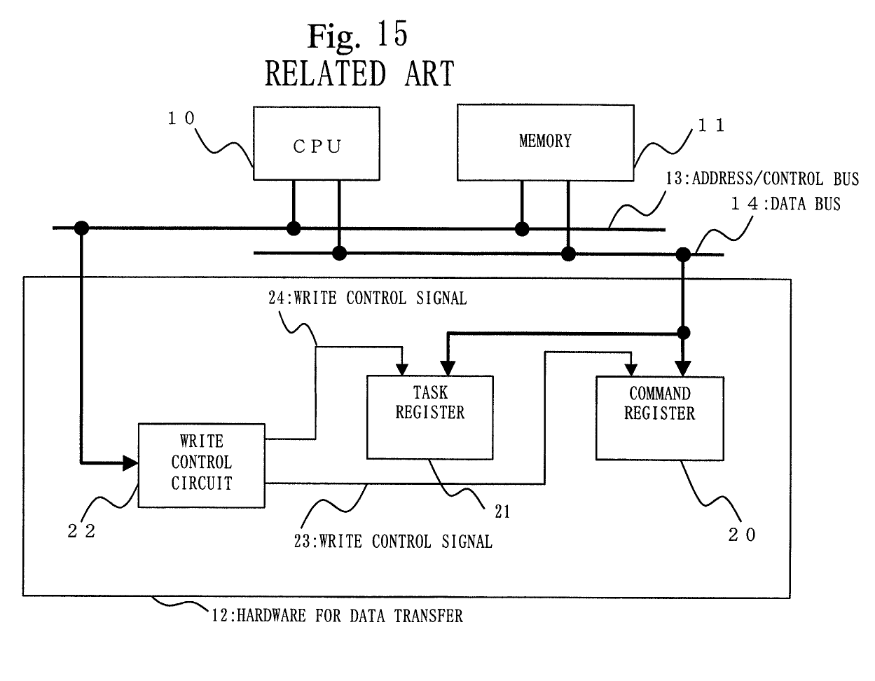

FIG. 16 shows an operation of the conventional software;

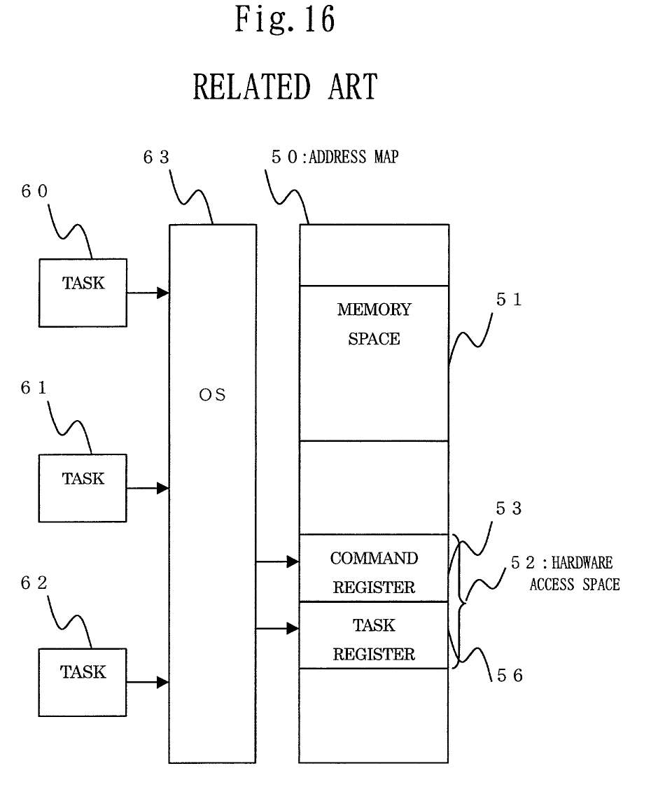

FIG. 17 shows an organization of a control apparatus for data transfer according to the twelfth embodiment;

FIG. 18 shows an organization of a control apparatus for data transfer according to the thirteenth embodiment; and

FIG. 19 shows an organization of a control apparatus for data transfer according to the thirteenth embodiment.

### DESCRIPTION OF THE PREFERRED EMBODIMENT

### Embodiment 1

In the following, the present invention will be explained in reference to the drawings showing various embodiments.

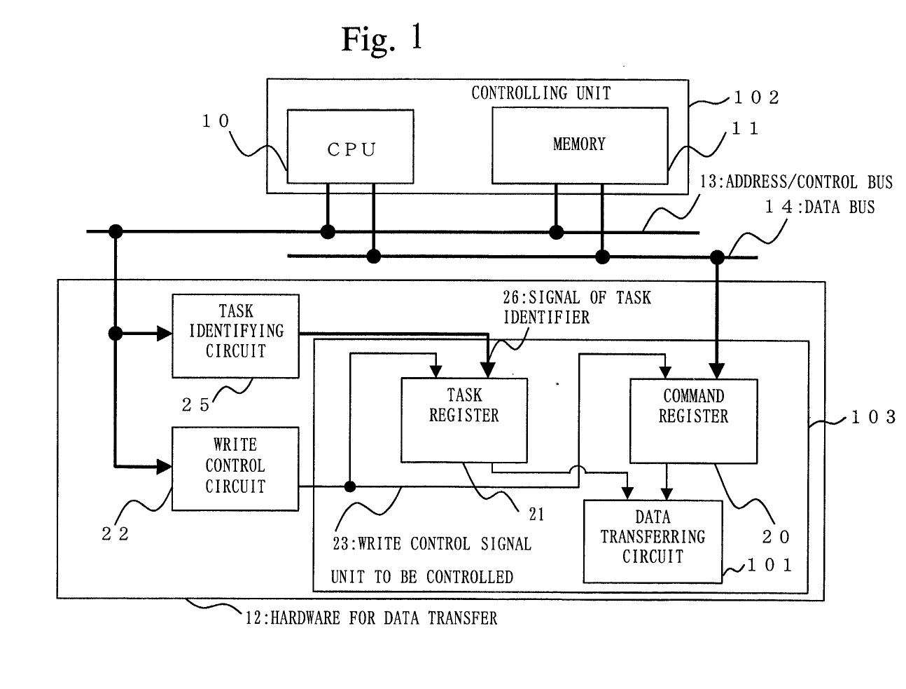

FIG. 1 shows an organization of a control apparatus for data transfer according to the first embodiment. The control apparatus for data transfer is one of the control apparatuss as embodiments of the present invention. The control apparatus of the invention is not limited to the control apparatus for data transfer, but also used for controlling other kind of circuit which does not aim to transfer data.

In the figure, a reference numeral 10 shows a CPU for performing processing, control, and so on. (Here, the CPU is an example of a processing apparatus.) 11 shows a memory for storing commands and data required for the operation of the CPU 10. (The memory 11 is an example of an OS program memory and a task program memory.) 12 shows a hardware for data transfer performing data transfer. The hardware 12 for data transfer is controlled by the CPU 10. 13 is an address/control bus for connecting the CPU 10, the memory 11 and the hardware 12 for data transfer. (The address/control bus 13 is an example of a bus.) The address/control bus 13 transfers an address and a control signal. Here, an address means for example, a physical address. The control information is used for controlling. 14 is a data bus for connecting the CPU 10, the memory 11 and the hardware 12 for data transfer. (The data bus 14 is an example of a bus.) The data bus 14 transfers data.

A reference numeral 20 shows a command register in which a transfer command is set. (The command register 20 is an example of a control information memory.) The command register 20 is included in the hardware for data transfer. 21 shows a task register in which a task identifier is set. (The task register 21 is an example of an attribute information memory.) The task register 21 is included in the hardware 12 for data transfer. A write control circuit 22 controls write operation into the command register 20 and the task register 21. The write control circuit 22 is included in the hardware 12 for data transfer. A reference numeral 23 is a write control signal issued for controlling write operation to the command register 20 and the task register 21 by the write control circuit 22. 25 is a task identifying circuit for identifying the task. (The task identifying circuit 25 is an example of an attribute information identifying circuit.) The task identifying circuit 25 generates the task identifier corresponding to each task. Generally, the task identifier corresponding to each task is controlled by the operating system. However, this embodiment is configured so that the task identifying circuit 25 generates the task identifier corresponding to each task based on all or a part of the address. 26 is a signal of the task identifier supplied from the task identifying circuit 25 to the task register 21. (The signal 26 of the task identifier is an example of an attribute information and a part of information controlled by the operating system.) 101 shows a data transferring circuit to be controlled. The data transferring circuit 101 inputs the transfer command from the command register 20, inputs the signal of the task identifier from the task register 21, and performs the data transfer. (The data transferring circuit 101 is an example of a circuit to be controlled.) Any circuit can be applied to the circuit to be controlled.

A reference numeral 102 shows a controlling unit. 103 shows a unit to be controlled. (The unit 103 to be controlled is an identical object to be controlled.)

Next, an operation of the hardware will be explained. The CPU 10 reads an instruction and data stored in the memory 11. At this time, the CPU 10 reads the instruction and the data from the memory 11 via the address/control bus 13 and the data bus 14. In this example, two buses are used, however, one bus can be also used. Namely, any kind of bus system can be used for this example. The CPU 10 operates based on the instruction and the data.

A case where the CPU 10 sets the transfer command in the command register 20 will be explained. The CPU 10 outputs the address of the command register 20 and a write request to the address/control bus 13. Simultaneously, the CPU 10 outputs the transfer command to be set in the command register 20 to the data bus 14.

The write control circuit 22 detects the address and the write request. The write control circuit 22 recognizes a write cycle to the command register 20 based on the detection of the address and the write request. On recognizing the write cycle, the write control circuit 22 outputs the write control signal 23. To output the write control signal 23 indicates to write in the command register 20.

At timing of receiving the write control signal 23, the command register 20 takes in and holds the transfer command from the data bus 14. Through the above operation, the transfer command is set in the command register 20 from the CPU.

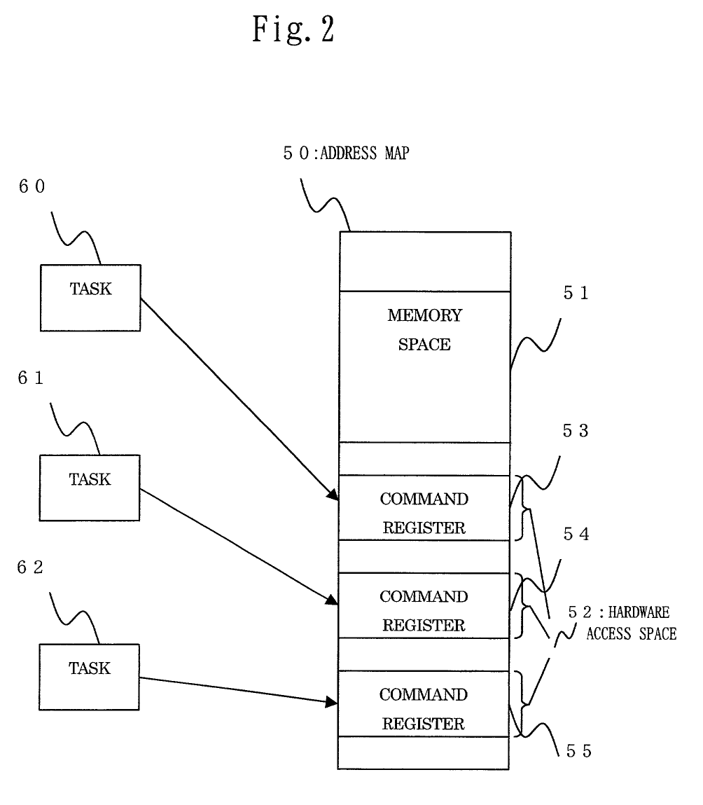

In the following, an operation will be explained in case the CPU 10 sets the task identifier in the task register 21. FIG. 2 shows an operation of the software according to the first embodiment of the invention. In the figure, 50 shows an address map, 51 shows a memory space for accessing the memory 11, 52 shows a hardware access space for accessing the hardware 12 for data transfer, 53 through 55 are command register spaces for accessing the command register 20, and 60 through 62 are tasks which are programs for the user.

Next, an operation of the software will be explained. The software operated on the CPU 10 can access the memory 11 via the memory space 51 included in the address map 50. Further, the software operated on the CPU 10 can access the command register 20 via the command register spaces 53 through 55. Here, it is predetermined that the task 60 accesses the command register 20 via the command register space 53, the task 61 accesses the command register 20 via the command register space 54, and the task 62 accesses the command register 20 via the command register space 55. Namely, in this example, the plural tasks correspond to the plural access spaces (in this example, the command register spaces) one by one, respectively. Each element stores this corresponding relation, or operates based on the corresponding relation.

As described above, the command register 20 includes the plural command register spaces 53 through 55. And, simultaneous with the timing of setting the transfer command in the command register 20, the task identifying circuit 25 decodes the address on the address/control bus 13. By decoding, the task identifying circuit 25 identifies the command register space used for accessing from the plural command register spaces 53 through 55. Further, the task identifying circuit 25 identifies the task corresponding to the identified command register space based on the corresponding relation between one of the tasks 60 through 62 used for accessing the command register 20 and one of the command register spaces 53 through 55 used for accessing the command register 20. Then, the task identifying circuit 25 outputs the signal 26 of the task identifier corresponding to the identified task.

The task register 21 takes in the signal 26 of the task identifier at the timing of receiving the write control signal 23 and the task register 21 holds the signal 26. Through the above operation, when the CPU 10 sets the transfer command (an example of control information) in the command register 20, the task identifier (an example of attribute information) corresponding to the transfer command is simultaneously set in the task register 21.

As has been described, the control apparatus according to the first embodiment includes the plural hardware access spaces for accessing the hardware for data transfer, and the control apparatus identifies the attribute information for access using the address used for accessing the hardware access space. In this embodiment, notwithstanding directly accessing the hardware for data transfer by the task that controls the hardware for data transfer without accessing via the operating system, a correct attribute information can be always set. Accordingly, the embodiment provides a secure transfer control and prevents the degradation of the processing performance because of accessing via the operating system.

The plural tasks are respectively made correspondence with the access spaces, which enables to specify the attribute information based on the address transferred by the task. Therefore, the correspondence between plural pairs each of the tasks and its corresponding access space and the attribute information is made.

Since the attribute information is specified by decoding, it is easy to specify the attribute information.

Further, the unit to be controlled can be controlled smoothly because the control information memory and the attribute information memory are provided.

The write control circuit detects the write instruction when the address is included within a specific range, which prevents a malfunction.

The control apparatus controls the data transferring circuit, which enables to transfer data at a high speed.

The controlling unit controls the unit to be controlled using one request, so that it is possible to control the unit to be controlled consistently even if plural tasks are made correspondence with one hardware. This is because an unexpected access will not occur by another task during a series of the operation.

### Embodiment 2

In the above first embodiment, the signal of the task identifier, which is one of the attribute information, is generated by decoding the address used for accessing the hardware for data transfer. In the second embodiment, another control method will be explained where the task identifier is specified as the attribute information by referring to the attribute table.

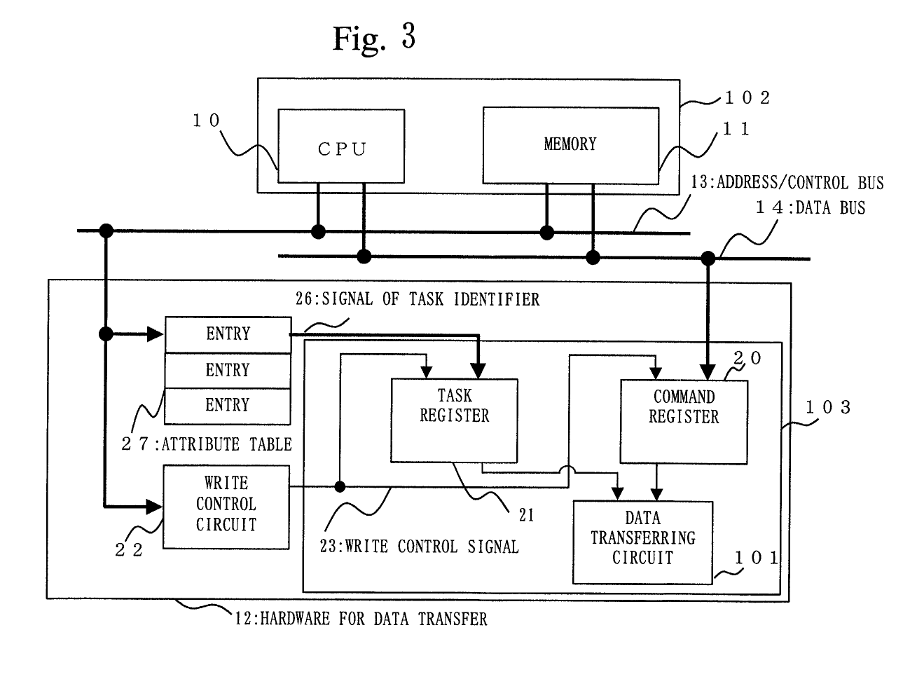

FIG. 3 shows an organization of the data transfer control apparatus according to the second embodiment. In the figure, the reference numerals 10 through 14, 20 through 23, 26, and 101 through 103 are the same as ones shown in FIG. 1, therefore, the explanation will be omitted. 27 shows an attribute table for storing the task identifier as the attribute information. (The attribute table 27 is an example of an attribute information identifying circuit.)

In the following, an operation will be described. The operation up to setting the transfer command in the command register 20 by the CPU 10 is the same with the first embodiment, therefore, the explanation will be omitted. The attribute table 27 includes plural entries. (These entries are examples of attribute entries.) The task identifier corresponding to each task is already stored in the entry. The task identifier corresponding to the task is a kind of information that is usually controlled by the operating system. In the present embodiment, the task identifier and the corresponding relation with the task is previously stored in the attribute table 27 as an entry. However, any method or any timing can be applied to the method and the timing for storing such information. For example, such information can be stored at the stage of producing the task identifying circuit, or such information is set by the operating system via bus. The attribute table 27 specifies one entry using a part of or all of address used for accessing the hardware access space (the command register space) as an index. Then, the task identifier stored in the entry is selected and output as the signal 26 of the task identifier.

The task register 21 takes in the signal 26 of the task identifier at the timing of receiving the write control signal 23 and the task register 21 holds the signal 26. Through the above operation, the transfer command (an example of control information) is set in the task register 20 from the CPU 10, and at the same time, the task identifier (an example of attribute information) is set in the task register 21.

As described above, the control apparatus according to the second embodiment specifies the attribute information by reference to the attribute table using the address, which is used for accessing the hardware access space, as the index. Accordingly, the second embodiment can provide the same effect with the first embodiment, and further, the organization can be facilitated.

Further, in the second embodiment, the task identifier corresponding to the address of the hardware access space is stored in the attribute table, therefore, a flexible correspondence can be made by changing the contents of the attribute table.

According to the present embodiment, the control apparatus includes plural attribute entries respectively storing attribute information, specifies one of the attribute entries by the physical address, and obtains the attribute information. Therefore, a flexible control can be accomplished by the way of supplementing the control information with the attribute information.

### Embodiment 3

In the third embodiment, another case will be explained where the control information for the hardware for data transfer and the attribute information corresponding to the control information is queued.

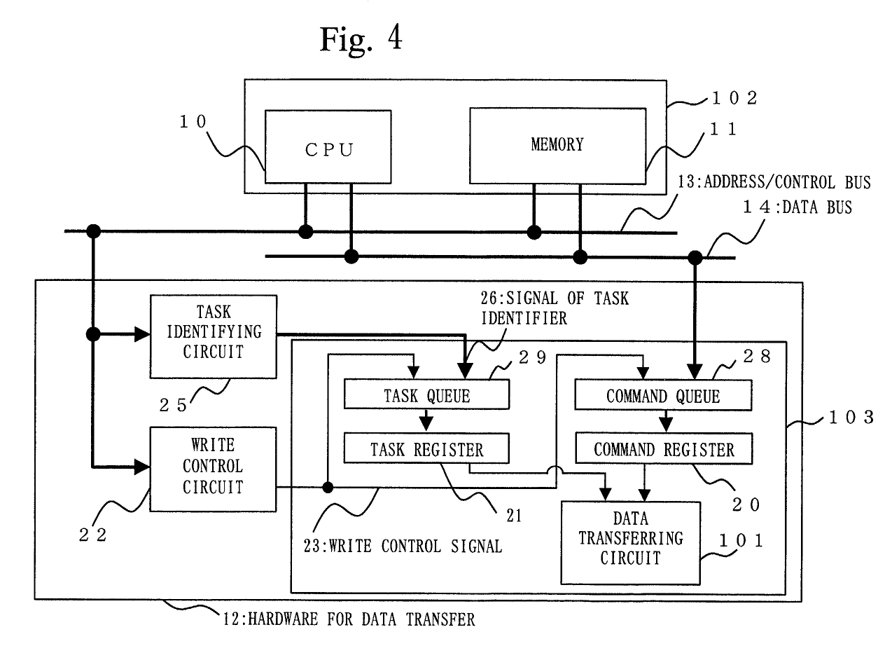

FIG. 4 shows an organization of the data transfer control apparatus according to the third embodiment. In the figure, the reference numerals 10 through 14, 20 through 23, 25, 26, and 101 through 103 are the same as ones in FIG. 1 etc., therefore, the explanation will be omitted. A reference numeral 28 is a command queue for queuing the transfer command set in the command register 20. (The command queue 28 is an example of control information queue and the command register 20 is an example of control information register.) 29 is a task queue for queuing the task identifier set in the task register 21. (The task queue 29 is an example of attribute information queue and the task register 21 is an example of attribute information register.)

Next, the operation will be described. The CPU 10 reads the instruction and the data stored in the memory 11. At this time, the CPU 10 reads the instruction and the data via the address/control bus 13 and the data bus 14. The CPU 10 operates based on the instruction and the data.

A case will be explained in which the CPU 10 sets the transfer command in the command register 20. The CPU 10 outputs the address of the command register 20 and the write request to the address/control bus 13. Simultaneously, the CPU 10 outputs the transfer command to be set in the command register to the data bus 14.

The write control circuit 22 detects the address and the write request. The write control circuit 22 recognizes a write cycle to the command queue 28 by the detection of the address and the write request. The write control circuit 22 outputs the write control signal 23. To output the write control signal 23 indicates to write on the command queue 28 and on the task queue 29.

The command queue 28 takes in the transfer command from the data bus 14 at the timing of receiving the write control signal 23 and the command queue 28 holds the transfer command. The transfer command held in the command queue 28 is output at a predetermined timing, and the transfer command is set in the command register 20. The predetermined timing is for example, a completion of the process of the data transferring circuit 101 using the previous transfer command, which has been set in the command register 20 prior to setting the present transfer command. For another example, the predetermined timing is a transfer of the previous transfer command, which has been set in the command register 20 prior to the present transfer command, to the data transferring circuit 101 (an example of the circuit to be controlled). In the above operation, the CPU 10 sets the transfer command in the command register 20 via the command queue 28.

The command register 20 includes plural command register spaces. At the same timing of setting the transfer command in the command queue 28, the task identifying circuit 25 decodes the address on the address/control bus 13. By decoding, the task identifying circuit 25 identifies one of the plural command register spaces 53 through 55 used for accessing. As well as the first embodiment, the corresponding relation is predetermined between the task for accessing the command queue 28 and the command register space used for accessing the command queue 28 by the task. Based on this corresponding relation, the task identifying circuit 25 identifies the task that corresponds to the specific command register space. Then, the task identifying circuit outputs the signal 26 of the task identifier corresponding to the identified task.

The task queue 29 takes in the signal 26 of the task identifier at the timing of receiving the write control signal 23 and the task queue 28 holds the signal 26. The task identifier held in the task queue 29 is set in the task register 21 at the same timing of setting the transfer command held in the command queue 28, in the command register 20 as described above.

In this way, the control apparatus of the embodiment sets the transfer command in the command register 20 via the command queue 28 from the CPU 10 as the controlling information. And, at the same time, the task identifier, which is the attribute information corresponding to the controlling information, is set in the task register 21 via the task queue 29.

To queue the controlling information for the hardware for the data transfer and the attribute information corresponding to the controlling information promotes the process of the CPU. For example, before the hardware for the data transfer completes the process concerning the previous controlling information and the previous attribute information, the hardware for the data transfer can take in another controlling information and another attribute information to be used for the next process. Namely, the CPU can control the hardware for the data transfer without waiting for completion of the previous process of the hardware for the data transfer, which enables the CPU to reduce waiting time.

Since the control information memory includes the control information queue and the control information register, it becomes possible to input a next control information to the control information memory before the unit to be controlled inputs the control information. Therefore, the control can be processed faster.

Since the attribute information memory includes the attribute information queue and the attribute information register, it becomes possible to input a next attribute information to the attribute information memory before the unit to be controlled inputs the attribute information. Therefore, the control can be processed faster.

### Embodiment 4

In the fourth embodiment, another case will be explained in which the operating system maps the hardware access space within the task space of each task.

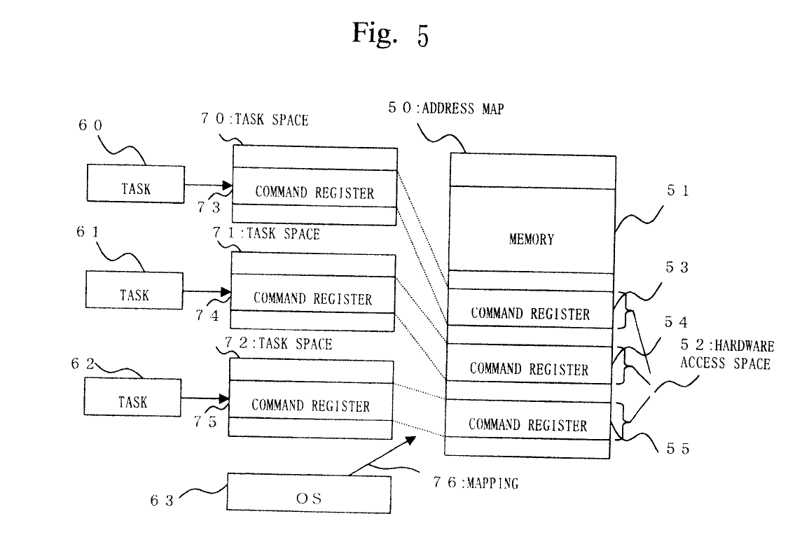

FIG. 5 shows an operation of the software according to the fourth embodiment. In the figure, reference numerals 50 through 55, and 60 through 63 are the same as ones in FIG. 2, therefore, the explanation is omitted. Task spaces 70 through 72 respectively correspond to the task 60 through 62. The task spaces 70 through 72 are permitted to respectively access from the tasks 60 through 62. Reference numerals 73 through 75 are command register spaces made by mapping the command register spaces 53 through 55. The command register spaces 73 through 75 are mapped within the task spaces 70 through 72, respectively. 76 shows mapping by the operating system 63. This mapping means to locate the register spaces 53 through 55 in the task spaces 70 through 72.

The operation of FIG. 5 will be explained in the following. In case of a multi-task computer system, the operating system 63 assigns the task spaces 70 through 72 to the task 60 through 62, respectively. The task space is an address space which is allowed to be accessed by the task. Further, the operating system 63 performs mapping 76 of the command register spaces 53 through 55, which are the hardware access spaces 52, as the command register spaces 73 through 75, respectively. The operating system 63 permits the tasks 60 through 62 to access the command register spaces 73 through 75, respectively.

As described above, in case that the control apparatus is the multi-task computer system, each task is made capable to access the hardware for data transfer by mapping the hardware access spaces corresponding to plural tasks sharing the service supplied from the hardware for data transfer.

### Embodiment 5

In the fifth embodiment, the control apparatus comprising an access prohibiting function will be explained. The access prohibiting function means a function for prohibiting the task from accessing the hardware access spaces other than the task space corresponding to the task.

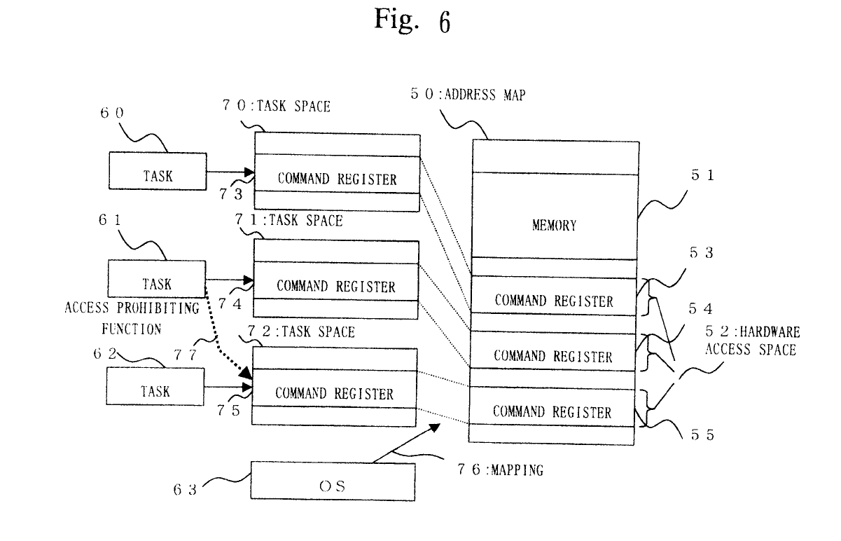

FIG. 6 shows an operation of the software according to the fifth embodiment. In the figure, the reference numerals 50 through 55, 60 through 63, and 70 through 76 are the same as ones in FIG. 5, therefore, the explanation is omitted. A reference numeral 77 shows an access prohibiting function.

Next, the operation will be described. As well as the operation shown in FIG. 5, the operating system 63 assigns the task spaces 70 through 72 to the tasks 60 through 62, respectively. Further, as shown by the mapping 76, the command register spaces 53 through 55 are mapped within the command register spaces 73 through 75, respectively. By this operation, the tasks 60 through 62 are permitted to access the command register spaces 73 through 75, respectively.

Here, it is assumed that the task 61 accesses the command register space (for example, the command register space 75), which is not mapped within the task space 71 corresponding to the task 61. Such an unexpected access may often occur due to the mistake in coding the task program. Further, since the task program is constructed by the user, it is extremely difficult to prevent such a mistake.

In the fifth embodiment, such kind of access request causes an error by the access prohibiting function. Namely, the unexpected access is not permitted nor executed. As a result, the task 61 cannot access the command register space 75 within the task space 72 corresponding to another task. It is possible to prevent the task 61 from accessing the command register via the command register space 55, which does not correspond to the task 61. By doing so, it is possible to prevent an improper operation of the data transferring circuit 101 due to a wrong address and a wrong transfer command transferred by the CPU.

As described above, the control apparatus of the embodiment includes the access prohibiting function for prohibiting the task from accessing the space which is not permitted to be accessed. Consequently, in case of accessing the hardware for the data transfer, an improper operation can be prevented such as setting a wrong controlling information or (and) a wrong attribute information. For example, the embodiment can be effectively applied to preventing the fault of the task program.

### Embodiment 6

In the sixth embodiment, one example of the above access prohibiting function will be explained. In this example, a task space protecting function of the operating system is utilized for the access prohibiting function. However, the access prohibiting function is not limited to this example.

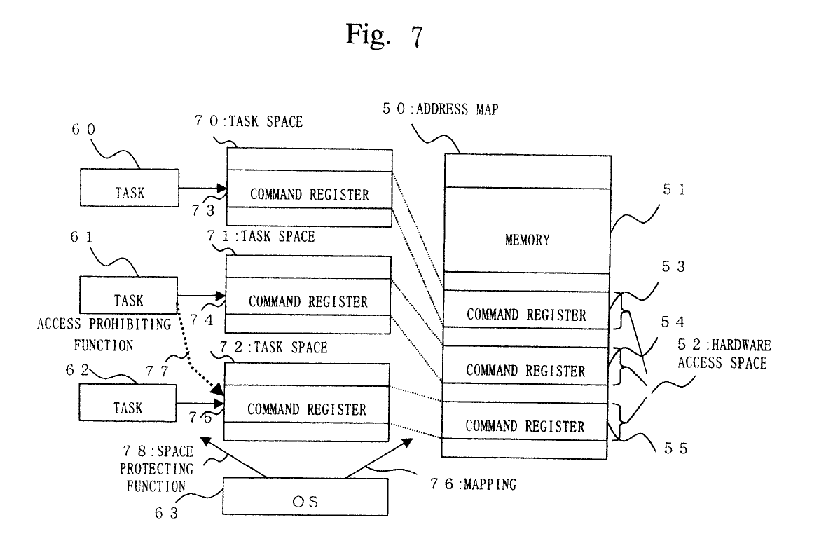

FIG. 7 shows an operation of the software according to the sixth embodiment. In the figure, the reference numerals 50 through 55, 60 through 63, and 70 through 77 are the same as ones in FIG. 6. A reference numeral 78 shows an operation of the task space protecting function of the operating system.

Next, the operation will be explained. As well as the operation shown in FIG. 6, the operating system 63 assigns the task spaces 70 through 72 to the tasks 60 through 62, respectively. Further, as shown by the mapping 76, the operating system 63 maps the command register spaces 53 through 55 within the command register spaces 73 through 75, respectively. By doing so, the tasks 60 through 62 are permitted to access the command registers 73 through 75, respectively.

Further, the task 61 is prohibited from accessing the command register space 75, which the task 61 is not permitted to access, by the access prohibiting function 77. Accordingly, the improper operation can be avoided such that a wrong transfer command is set in the command register and a wrong task identifier is set in the task register. In the sixth embodiment, the access prohibiting function 77 is implemented by the task space protecting function of the operating system 63.

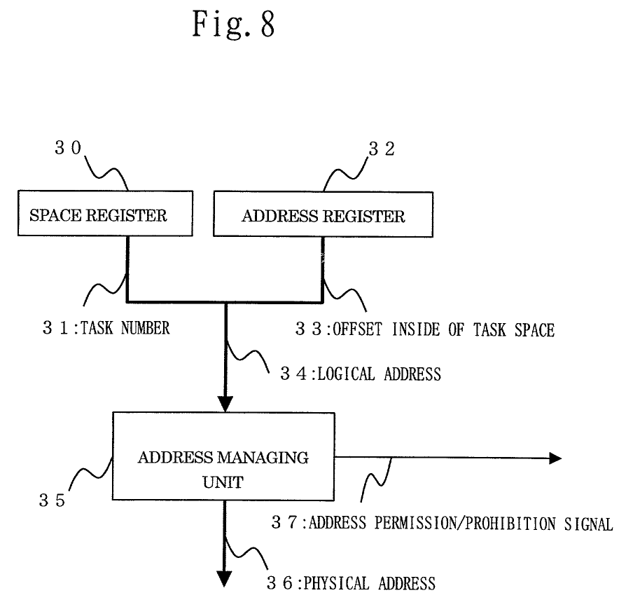

FIG. 8 shows an organization of a circuit for performing the task space protecting function 78. The circuit shown in the figure is implemented inside of the CPU 10. The operating system 63 performs the task space protecting function 78 by controlling this circuit. In the figure, a reference numeral 30 shows a space register for setting information (hereinafter, a task number is used, for example) specifying a logical address space assigned to software being executed by the CPU 10 therein. A reference numeral 31 shows the task number. 32 shows an address register for setting an address (hereinafter, an offset inside of the task space for example) referred to by the software being executed by the CPU 10. 33 shows an offset inside of the task space. 34 shows a logical address. 35 shows an address managing unit for performing space protection based on the logical address 34. 36 shows a physical address. 37 denotes an access permission/prohibition signal. The access permission/prohibition signal is generated for controlling the space protection.

Next, an operation of the task space protecting function 78 will be explained. The operating system 63 previously sets the address managing unit 35 inside of the CPU 10. By this setting, the mapping function 76 permits the task to access the physical address of the hardware access space via the task space corresponding to the task. The operating system 63 sets the task number in the space register 30 before activating the task. By this operation, a specific logical address space, namely, the task space is assigned to each task.

The task sets the offset inside of the task space in the address register 32 on accessing the hardware access space. The offset 33 inside of the task space set in the address register 32 is concatenated with the task number 31 set in the space register 30. Consequently, the logical address 34 is generated. This logical address 34 is transferred to the address managing unit 35. The address managing unit 35 generates the physical address 36 corresponding to the logical address 34. Further, the address managing unit 35 generates the access permission/prohibition signal 37 based on the logical address 34. The protection of the task space can be made by the signal.

In the following, an example case is explained in which the access by the task is permitted by the operating system 63. For example, a case is assumed that the task 61 shown in FIG. 7 accesses the command register space 74. First, the operating system 63 previously maps the command register space 54 to the command register space 74 within the task space 71 corresponding to the task 61.

The task number of the task 61 is set in the space register 30 before the task 61 is activated by the operating system 63. Here, it is assumed that the task 61 accesses the command register space 74 after the task 61 is activated. First, the task 61 sets the address (the offset inside of the task space) of the command register space 74 in the address register 32. Next, when an instruction to access this address is executed, the offset inside of the task space 33 set in the address register 32 is concatenated with the task number 31 set in the space register 30. By this concatenation, the logical address 34 is generated. Then, this logical address is transferred to the address managing unit 35. The address managing unit 35 discriminates this address as permitted by referring to the information previously set by the operating system 63. The address managing unit 35 converts the logical address 34 into the physical address 36. Simultaneously, the address managing unit 35 outputs the permission of access as the access permission/prohibition signal 37. As a result, the CPU 10 controls the address/control bus 13 and the data bus 14 so as to access the command register space 54.

Next, another example will be explained in which the access by the task is not permitted by the operating system 63. For example, it is assumed that the task 61 shown in FIG. 7 accesses the command register space 75. First, the operating system 63 previously performs mapping. At this time, the command register space 55 is mapped within the task space 72 corresponding to the task 62, not mapped within the task space 71 corresponding to the task 61.

Before the operating system 63 activates the task 61, the task number of the task 61 is set in the space register 30. It is assumed that the task 61 accesses the command register space 75 after the task 61 is activated. First, the task 61 sets the address (the offset within the task space) of the command register space 75 in the address register 32. Next, when the instruction to access this address is executed, the offset 33 inside of the task space set in the address register 32 is concatenated with the task number 31 set in the space register 30. By this concatenation, the logical address 34 is generated. Then, the logical address is transferred to the address managing unit 35. The address managing unit 35 discriminates the access as not permitted by referring to the information previously set by the operating system 63. The address managing unit 35 outputs the access prohibition as the access permission/prohibition signal 37. As a result, the CPU 10 does not access the address/control bus 13 nor the data bus 14, which results in generating an error.

As described above, the access prohibiting function is implemented by using the space protecting function which the operating system comprises, so that it is not required to extend the hardware in accordance with the implementation of the access prohibiting function.

Since the physical address transferred by the operation of the task is limited within the access space corresponding to the task, an improper use of the attribute information which does not correspond to the task can be prevented, and thus the task can be protected.

The embodiment has explained a case where one set of the unit to be controlled as an object to be controlled and plural access spaces is provided, and further, this set can be plural.

### Embodiment 7

In the seventh embodiment, another case will be explained in which the attribute information for controlling the hardware for data transfer by accessing the hardware access space includes information relating the data sender.

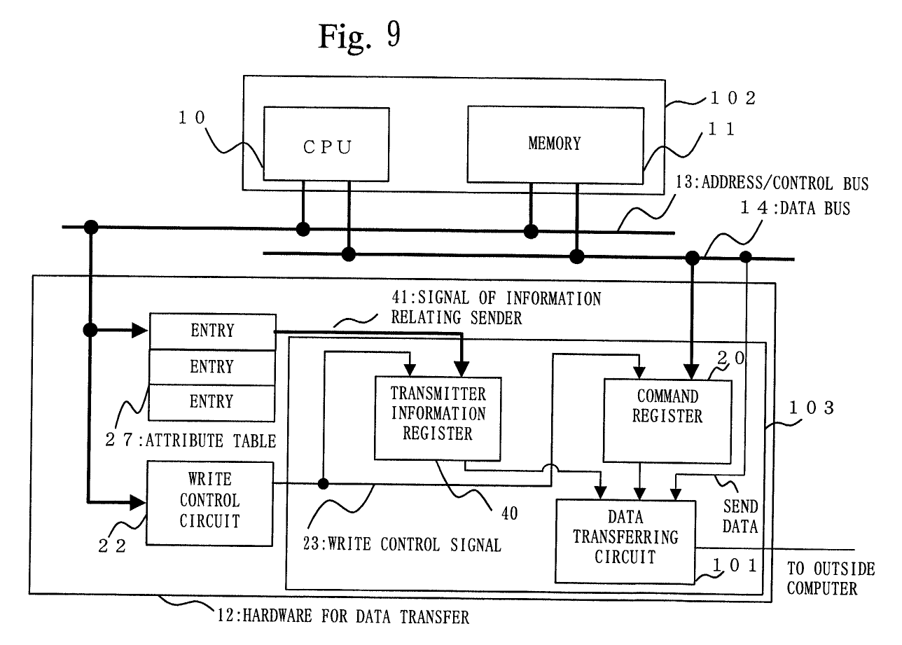

FIG. 9 shows an organization of the control apparatus for data transfer according to the seventh embodiment. In the figure, reference numerals 10 through 14, 20, 22, 23, and 101 through 103 are the same as ones shown in FIG. 1, and the explanation of these are omitted here. (Here, the memory 11 is an example of the send data memory.) A reference numeral 27 shows an attribute table for storing information relating the data sender. The information relating the data sender is one of examples of the attribute information. 40 shows a sender information register for setting the information relating the sender therein. 41 shows a signal of the information relating the sender. (The signal 41 is an example of the attribute information.) The signal 41 provides the sender information register 40 with the information relating the data sender.

Next, an operation will be explained. The operation up to setting the transfer command in the command register 20 by the CPU 10 is the same with the operation of the first embodiment, and the explanation is omitted here. The attribute table 27 includes plural entries. In these entries, information relating the data sender is previously stored. The information relating the data sender is, for example, an identifier of the computer system (an example of the control apparatus) for issuing the command of data transfer, the identifier of the task for controlling the data transfer and so on. Usually, the operating system manages the same kind of information as these. The information is set in the entries of the attribute table so as to match the information managed by the operating system. In the present embodiment, the information relating the data sender is previously stored in the attribute table 27 in a form of entry. However, any method or any timing for storing the information can be applied to storing the information. This is the same with the first embodiment. The attribute table 27 utilizes a part of or all of address used for accessing the hardware access space (command register space) as an index to specify one entry. Then, the information relating the data sender stored as the entry is output as the signal 41 of the information relating the data sender.

The sender information register 40 takes in the signal 41 of the information relating the data sender at timing of receiving the write control signal 23, and holds the signal 41. Through the above operation, simultaneously with the access to set the transfer command (an example of the control information) in the command register 20 by the CPU, the information relating the data sender (an example of the attribute information), which corresponds to the access, is set in the sender information register 40.

The data transferring circuit 101 transfers the data using the information relating the data sender. In another way, the information relating the data sender is sometimes appended to the send data. Then, the information appended to the send data is sometimes utilized in the transfer channel or by the computer system of the receiver.

As described above, it is possible to set the information relating the data sender used for the data transfer simultaneously with the access to the hardware for data transfer. Accordingly, the control information supplied to the hardware for data transfer at each access to the hardware for data transfer can be reduced. Further, a reliability of the data transfer can be kept.

The attribute information is logically identical to the OS management information, which reduces the process of the OS.

Since the attribute information is the information relating the data sender, it is possible to input the information relating the data sender required for the data transfer to the data transferring circuit quickly and correctly.

### Embodiment 8

In this section, another embodiment in which the attribute information for controlling the hardware for data transfer by accessing the hardware access space includes the information relating the data receiver will be explained.

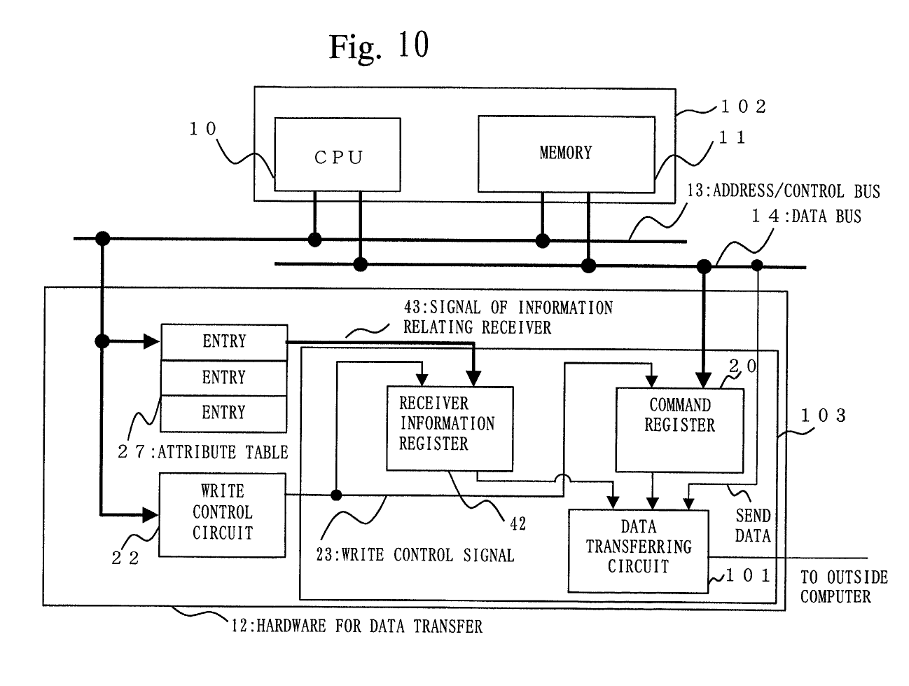

FIG. 10 shows an organization of a control apparatus for data transfer according to the eighth embodiment. In the figure, reference numerals 10 through 14, 20, 22, 23, and 101 through 103 are the same elements with ones in FIG. 1, and their explanation will be omitted here. A reference numeral 27 shows an attribute table for storing the information relating the data receiver. The information relating the data receiver is one example of the attribute information. 42 shows a receiver information register for setting the information relating the data receiver. 43 shows a signal of the information relating the data receiver. (The signal 43 is an example of the attribute information.) The signal 43 supplies the information relating the data receiver to the receiver information register 42.

An operation will be explained in the following. The operation up to setting the transfer command in the command register 20 by the CPU 10 is the same with the first embodiment, and the explanation will be omitted here. The attribute table 27 includes plural entries. In these entries, the information relating the data receiver is previously stored. The information relating the data receiver is, for example, an identifier of the computer system (an example of an external computer) which is the designation of the data transfer, an identifier of the task which is to receive the send data, etc. The operating system sometimes manages the same kind of information with these information. In such a case, the information stored in the entry is set so as to match the information managed by the operating system. In this embodiment, the information relating the data receiver is previously stored in the attribute table 27 as the entry. However, any kind of method and any timing for storing these information can be applied to the eighth embodiment. This is the same as the first embodiment. The attribute table 27 utilizes a part of or all of the address used for accessing the hardware access space (the command register space) as an index and specifies one entry. Then, the information relating the data receiver stored in the specified entry is output as the signal 43 of the information relating the data receiver.

The receiver information register 42 takes in the signal 43 of the information relating the data receiver at the timing of receiving the write control signal 23, and the receiver information register 42 holds the signal 43. Through the above operation, simultaneous with the access to set the transfer command (an example of the control information) in the command register 20 by the CPU 10, the information relating the data receiver (an example of the attribute information), which corresponds to the access, is set in the receiver information register 42.

The data transferring circuit 101 transfers the data using the information relating the data receiver. In another way, the information relating the data receiver is sometimes appended to the send data. And, the information transferred with the data is sometimes used in the transfer channel or by the computer system of the data receiver.

As described above, it is possible to set the information relating the data receiver used for the data transfer simultaneously with the access to the hardware for data transfer. Accordingly, the control information supplied to the hardware for data transfer at each access to the hardware for data transfer can be reduced. Further, a reliability of the data transfer can be kept.

Since the attribute information is the information relating the data receiver, it is possible to input the information relating the data receiver required for the data transfer to the data transferring circuit quickly and correctly.

### Embodiment 9

In this section, another embodiment in which the attribute information for controlling the hardware for data transfer by accessing the hardware access space includes the information relating the send data will be explained.

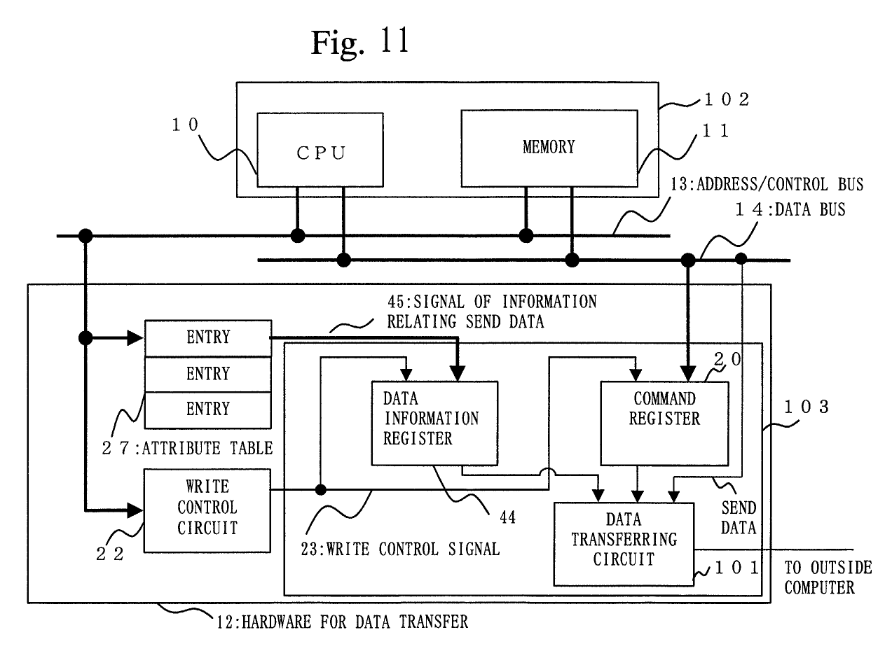

FIG. 11 shows an organization of a control apparatus for data transfer according to the ninth embodiment. In the figure, reference numerals 10 through 14, 20, 22, 23, and 101 through 103 are the same elements with ones in FIG. 1, and their explanation will be omitted here. A reference numeral 27 shows the attribute table for storing the information relating the send data. The information relating the send data is one example of the attribute information. 44 shows a data information register for setting the information relating the send data. 45 shows a signal of the information relating the send data. The signal 45 is an example of the attribute information and supplies the information relating the send data to the data information register 44.

An operation will be explained in the following. The operation up to setting the transfer command in the command register 20 by the CPU 10 is the same with the first embodiment, and the explanation will be omitted here. The attribute table 27 includes plural entries. In these entries, the information relating the send data is previously stored. The information relating the send data is, for example, an address for storing the send data, a kind of the data, amount of the data, encrypting system of the data, encryption key of the data, etc. The operating system sometimes manages the same kind of information with these information. In this case, the information stored in the entry is set so as to match the information managed by the operating system. In this embodiment, the information relating the send data is previously stored in the attribute table 27 as the entry. However, any kind of method and any timing for storing these information can be applied to the ninth embodiment. This is the same as the first embodiment. The attribute table 27 utilizes a part of or all of the address used for accessing the hardware access space (the command register space) as an index and specifies one entry. Then, the information relating the send data stored in the specified entry is output as the signal 45 of the information relating the send data.

The data information register 44 takes in the signal 45 of the information relating the send data at the timing of receiving the write control signal 23, and the data information register 44 holds the signal 45. Through the above operation, simultaneous with the access to set the transfer command (an example of the control information) in the command register 20 by the CPU 10, the information (an example of the attribute information) relating the send data, which corresponds to the access, is set in the data information register 44.

The data transferring circuit 101 transfers the data using the information relating the send data. In another way, the information relating the send data is sometimes appended to the send data. And, the information transferred with the data is sometimes used in the transfer channel or by the computer system of the data receiver.

As described above, it is possible to set the information relating the send data used for the data transfer simultaneously with the access to the hardware for data transfer. Accordingly, the control information supplied to the hardware for data transfer at each access to the hardware for data transfer can be reduced. Further, a reliability of the data transfer can be kept.

Since the attribute information is the information relating the send data, it is possible to input the information relating the send data required for the data transfer to the data transferring circuit quickly and correctly.

### Embodiment 10

In this section, another embodiment in which the attribute information for controlling the hardware for data transfer by accessing the hardware access space includes plural kinds of information will be explained. In the foregoing embodiments, only one kind of information is included in the attribute information, however, in the present embodiment, plural kinds of information such as the information relating the data receiver, the information relating the data sender, and the information relating the send data are combined and set as the attribute information.

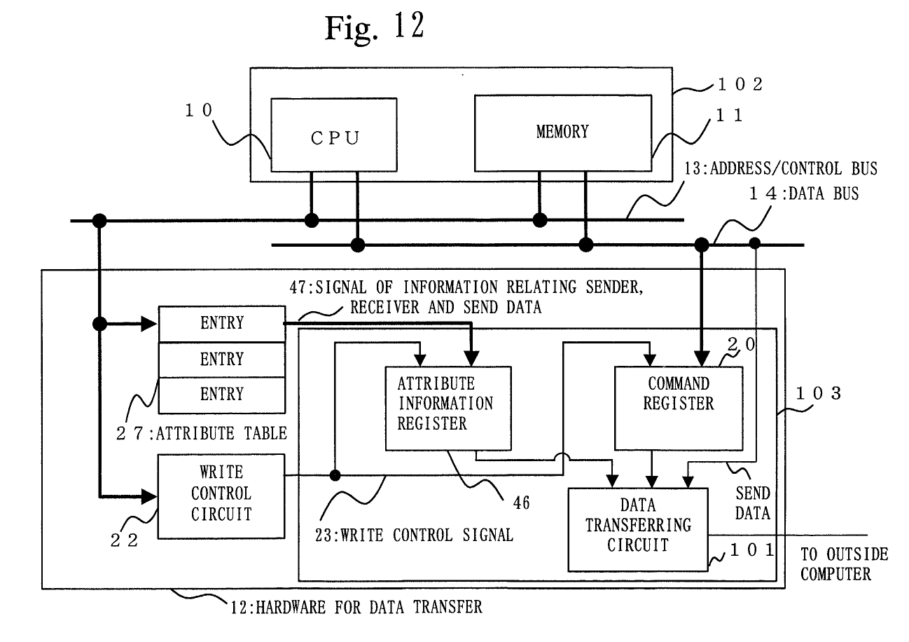

FIG. 12 shows an organization of a control apparatus for data transfer according to the tenth embodiment. In the figure, reference numerals 10 through 14, 20, 22, 23, and 101 through 103 are the same elements with ones in FIG. 1, and their explanation will be omitted here. A reference numeral 27 shows an attribute table for storing the information relating the data receiver, the information relating the data sender, and the information relating the send data. (These kinds of information are examples of the attribute information.) 46 shows an attribute information register for setting the information relating the data sender, the information relating the data receiver, and the information relating the send data. 47 shows a signal of the information relating the data sender, the information relating the data receiver, and the information relating the send data (an example of the attribute information having plural kinds of information combined). The signal 47 supplies the information relating the data sender, the information relating the data receiver, and the information relating the send data to the attribute information register 46.

An operation will be explained in the following. The control apparatus according to the tenth embodiment operates in the same way as the above embodiments except for treating the combined plural kinds of information as a set. The combined attribute information is configured based on a certain rule. Consequently, when the data transferring circuit 101 reads the attribute information from the attribute information register, each of the attribute information can be read according to the rule. Further, the data transferring circuit 101 reads all of the attribute information, then the data transferring circuit 101 can utilize each of the attribute information according to the rule.

As described above, it is possible to set the plural kinds of attribute information used for the data transfer simultaneously with the access to the hardware for data transfer. Accordingly, the control information supplied to the hardware for data transfer at each access to the hardware for data transfer can be enormously reduced. The unit 103 to be controlled can be configured so as to operate on receiving one write control signal. Further, the control apparatus can control the unit 103 to be controlled by issuing one write request.

### Embodiment 11

In this section, another embodiment in which the attribute information is used for controlling the unit to be controlled.

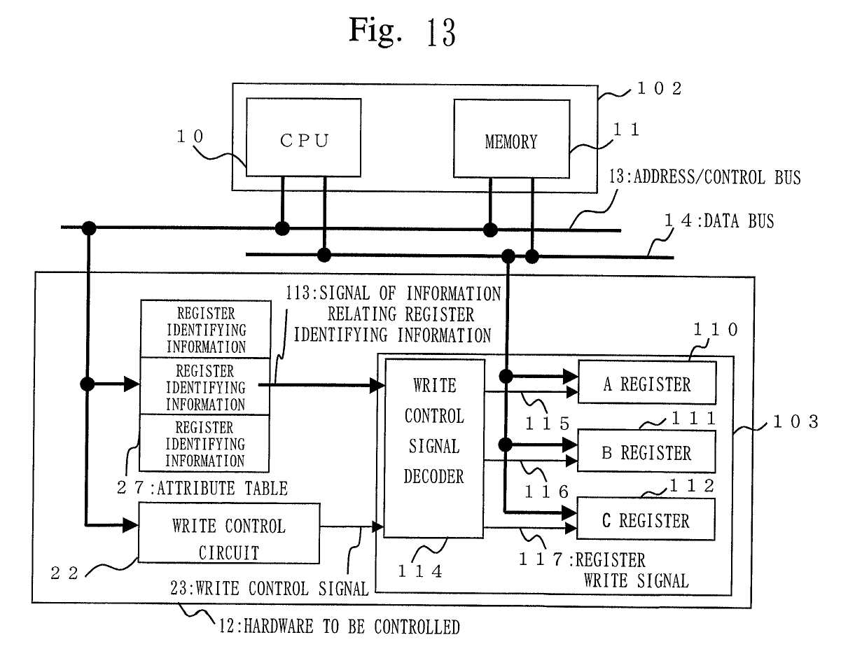

FIG. 13 shows an organization of a control apparatus for data transfer according to the eleventh embodiment. In the figure, reference numerals 10 through 14, 20, 22, 23, and 101 through 103 are the same elements with ones in FIG. 1, and their explanation will be omitted here. A reference numeral 27 shows an attribute table for storing the register identifying information. The register identifying information is one example of the attribute information. The register identifying information identifies the register described below. A reference numeral 110 shows A register, 111 shows B register, and 112 shows C register. 113 shows a signal relating the register identifying information output from the attribute table 27. 114 shows a write control signal decoder. The write control signal decoder 114 decodes the signal 113 relating the register identifying information at the timing of receiving the write control signal 23. 115 through 117 are register write signals for the A register 110, the B register 111, and the C register 112, respectively.

Next, an operation will be explained. The CPU 10 reads the instructions and the data stored in the memory 11 via the address/control bus 13 and the data bus 14, and the CPU 10 operates based on the instructions and the data. When the CPU 10 sets the data in the hardware 12 to be controlled, the CPU 10 outputs the addresses of the registers 110 through 112 and the write request to the address/control bus 13 and outputs the data to be set to the data bus 14. When the write control circuit 22 detects the address and the write request, the write control circuit 22 recognizes the address and the write request as a write cycle to any of the registers and outputs the write control signal 23.

The register identifying information is previously stored in the entry of the attribute table 27. The storing method is the same with the above embodiments. The attribute table 27 selects one entry using a part of or all of the address for accessing the hardware access space (the address of the register) as an index. Then, the register identifying information stored in the selected entry is output as the signal 113 relating the register identifying information.

The write control signal decoder 114 decodes the signal 113 relating the register identifying information at the timing of receiving the write control signal 23, and outputs one of the register write signals 115 through 117.

When the register write signal 115 is output, the A register 110 takes in the data from the data bus 14. When the register write signal 116 is output, the B register 111 takes in the data in the data bus 14. When the register write signal 117 is output, the C register 112 takes in the data from the data bus 14. In this way, the register for writing the data is switched according to the attribute data stored in the attribute table 27.

As described above, it is possible to control the unit to be controlled using the attribute information which has been previously set. Accordingly, the amount of control information supplied to the hardware to be controlled at each access to the hardware can be reduced.

A various kinds of control can be performed because the control information can be dynamically changed by the task and the attribute information is predetermined.

The control information includes the control command, and therefore the operation of the unit to be controlled can be selected.

The attribute information includes a parameter, which facilitates the control.

### Embodiment 12

In the twelfth embodiment, another method will be explained, in which the write request from the bus is queued once, and the contents is extracted from the queue to specify the attribute information.

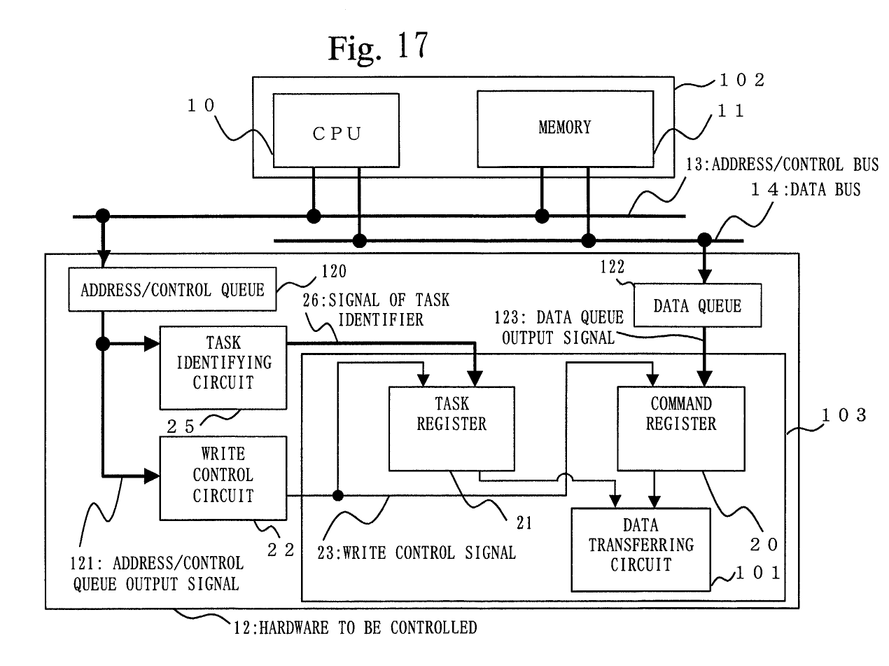

FIG. 17 shows an organization of a control apparatus for data transfer according to the twelfth embodiment.

A reference numeral 120 shows an address/control queue for queuing the address/control information. (The address/control queue 120 is an example of the first access information input queue.) 121 shows an address/control queue output signal which is output from the address/control queue 120. 122 shows a data queue for queuing the write data. (The data queue 122 is an example of the second access information input queue.) 123 shows a data queue output signal output from the data queue 122.

When the write request is issued from the CPU, the address/control queue 120 stores the information on the address/control bus 13. Simultaneously, the data queue 122 stores the data on the data bus 14. The write control circuit 22 generates the write control signal 23 based on the address/control queue output signal 121 at the time of completing the process of the data transferring circuit 101. By the write control signal 23, the command register 20 takes in the data queue output signal 123. Further, the task identifying circuit 25 generates the signal of the task identifier using a part of or all of an address of the address/control queue output signal 121. The task register 21 takes in the signal 26 of the task identifier based on the write control signal 23.

By configured as described above, the CPU 10 starts the next process without waiting for the completion of the process by the data transferring circuit 101, which improves the processing performance.

The attribute information input queue and the control information input queue are provided, so that it is possible to input the attribute information and the control information before the unit to be controlled completes the process. Consequently, the control can be processed quickly.

### Embodiment 13

Another case will be explained, where the controlling unit (CPU) is made to wait for accessing when the queue of the present embodiment becomes full. As a concrete procedure, the controlling unit is requested to wait until the queue becomes to have empty space, or the controlling unit is requested to retry. The queue of this case can be configured as the control information queue or the attribute information queue such as the command queue 28 or the task queue 29 shown in FIG. 4, or also can be configured as the queue for the bus information such as the data queue 122 shown in FIG. 17.

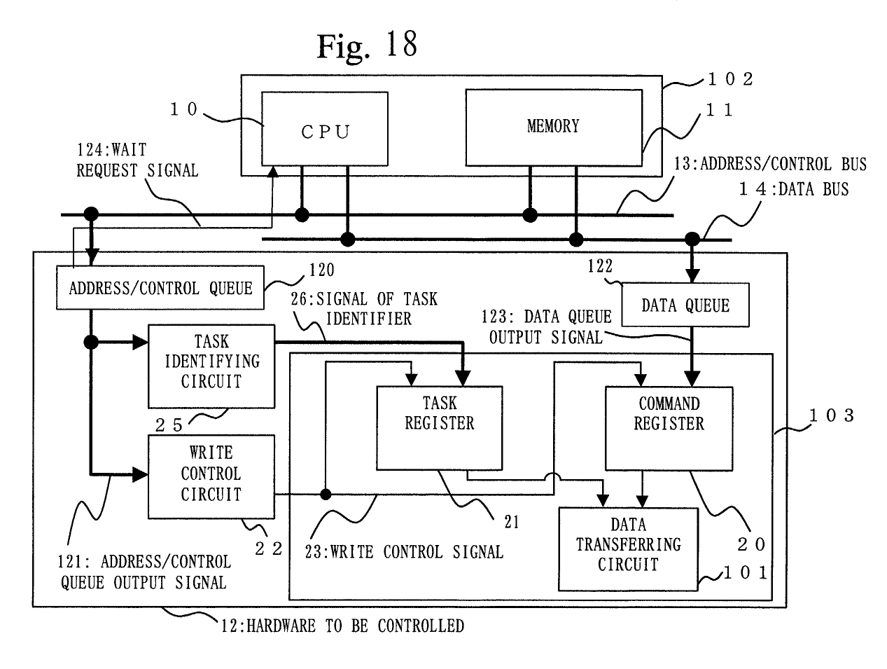

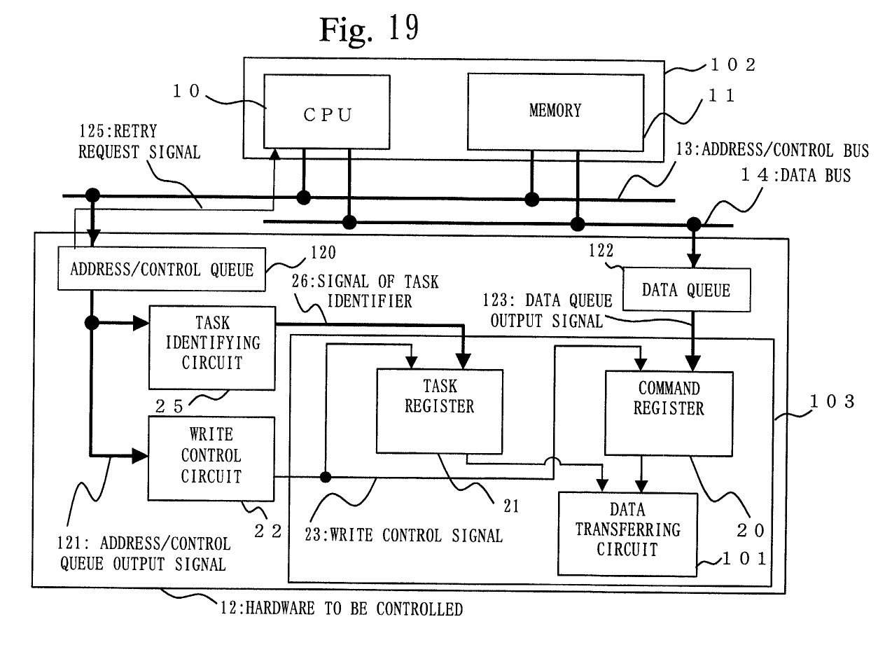

Examples of organization of the embodiment are shown in FIGS. 18 and 19.

In FIG. 18, a reference numeral 124 shows a wait request signal for the CPU 10. A case is assumed that the address/control queue 120 and the data queue 122 are full and cannot receive any further write request. If another write request is issued from the CPU 10, a wait request signal 124 is output to request the CPU 10 to wait until the queue becomes to have empty space. (The wait request signal 124 is an example of information for identifying necessity/unnecessity of the wait.) When the queue becomes to have empty space, the wait request signal 124 is released and the write request is taken in. This organization enables to prevent an overflow of the queue. The way to transmit the signal for inserting the wait request is not limited to this example, but the signal can be transmitted, for example, via the address/control bus 13. Further, the way to insert the wait request is not limited to a form of the wait request signal, but it is possible to insert the wait by not returning an acknowledge signal of the write request to the CPU 10 until the queue becomes to have empty space.

In FIG. 19, a reference numeral 125 shows a retry request signal for the CPU 10. (The retry request signal 125 is an example of information for identifying the necessity/unnecessity of the retry.) A case is assumed that the address/control queue 120 and the data queue 122 are full and cannot receive any further write request. If another write request is issued from the CPU 10, the retry request signal 125 is output to request the CPU 10 to retry. When the CPU 10 detects the retry request signal 125, the CPU 10 once releases the write request, which makes spaces in the address/control bus 13 and the data bus 14. After a certain time has passed, the CPU 10 issues the write request again. If the queue has empty space at this time, the retry request signal 125 is not output, and the address/control queue 120 and the data queue 122 take in the write request. An overflow of the queue can be prevented by this organization. Further, it is possible to prevent the address/control bus 13 and the data bus 14 from being occupied by the CPU 10 until the write request is received, and thus, other elements connected to the address/control bus 13 and the data bus 14 (not shown in the figure) can utilize these buses before the CPU 10 issues the write request again. Accordingly, it is possible to prevent the reduction of the system performance. The signal for requesting the retry is not limited to the above connection example, but the signal for requesting the retry can be transmitted via the address/control bus 13.

The information identifying the necessity/unnecessity of wait is output to make the controlling unit wait, which prevents an overflow of the queue.

The information identifying the necessity/unnecessity of retry is output to make the controlling unit retry, which enables to deal with the overflow of the queue.

In the foregoing embodiments, the control information is information dynamically set by the operation of the task. The control information is, for example, the control command (in this example, transfer command). This control command is input to the circuit to be controlled and is for selecting an operation executed by the circuit to be controlled. The control information can be a dynamically determined parameter. For example, the control information can be a storing location of the send data, which requires to be set at each data transfer.

Further, in the foregoing embodiments, the attribute information is information previously set before the operation of the above task. The attribute information is, for example, a parameter. The parameter is used for the operation based on the control information. For example, the attribute information can be a storing location of the send data, which does not require to be set at each data transfer.

Further, in the foregoing embodiments, the organization has been explained, in which the data is transferred between two computer systems. The application of the present invention is not limited to the data transfer between two computer systems. For example, the present invention can be effectively applied to an organization in which the data is transferred between one element to another in one computer system, or for another example, the invention can be applied to an organization in which the data is transferred among more than three computer systems.

Further, in the foregoing embodiment, the connection of the data transfer channel is assumed to be connected one to one. However, the application of the present invention is not limited to the organization of one to one connection. For example, the present invention can be effectively applied to a connection of one to multiple, a connection of multiple to multiple, or a connection of multiple to one. Other examples are organizations using a shared transfer channel, a switch and so on.

Further, the present invention can be applied to any kind of data to be transferred. For example, data for computation of the CPU, or a message for instructing the computation by the CPU, etc. can be used.

Further, in the foregoing embodiments, the element of the hardware for data transfer to be accessed has been assumed one command register. However, the application of the present invention is not limited to the case of one command register. For example, the present invention can be also effectively applied to a case in which the element to be accessed is other than the command register, or plural elements.

Further, in the foregoing embodiments, it has been assumed one queue for storing the control information and one queue for storing the attribute information corresponding to the control information are provided respectively. However, the present invention is not limited to the case in which only one queue is used. For example, the present invention can be effectively applied to a case in which plural queues are provided for storing the control information, or for storing the attribute information. Further, when the plural queues are provided, priority is set for each of inputs to or outputs from the plural queues and each queue is selected based on the priority set to the queue.

Further, the method embodying the task space protecting function of the operating system has been explained that the space register and the value of the address register are concatenated and the address controlling unit discriminates the information concatenated. However, another method can be applied.

Further, the attribute information cannot be limited to the above example. The control information cannot be limited to the above example.

Further, the controlling unit is explained using CPU. However, the controlling unit is not limited to the organization including the CPU. The controlling unit can be, for example, the bus interface circuit or the internet interface circuit, etc.

Further, in the foregoing embodiments, it has been assumed that one hardware access space corresponds to each task. However, the present invention is not limited to that case. The present invention can be also effectively applied to an organization in which plural access spaces correspond to one task. Further, the invention can be applied to an organization in which one access space corresponds to plural tasks.

Although the present invention has been described in terms of a preferred embodiment, it will be appreciated that various modifications and alterations might be made by those skilled in the art without departing from the spirit and scope of the invention. The invention should therefore be measured in terms of the claims which follow.

What is claimed is:

1. A control apparatus connected to a bus communicating a physical address, control information used for controlling, and a write request comprising:
(1) an attribute information identifying circuit connected to at least a part of the bus and including plural attribute entries, each of which stores attribute information, wherein
the attribute information identifying circuit receives at least a part of the physical address, specifies one attribute entry from the plural attribute entries based on the at least a part of the physical address received, and outputs the attribute information stored in the one attribute entry specified above;
(2) a write control circuit connected to the bus, wherein
the write control circuit receives the physical address and the write request from the bus, and outputs a write control signal when a write instruction is detected based on the physical address and the write request received; and
(3) a unit to be controlled connected to the bus, the write control circuit and the attribute information identifying circuit, wherein
the unit to be controlled inputs the write control signal, when the write control signal is input, the unit to be controlled receives the control information from the bus and inputs the attribute information output from the attribute information identifying circuit, and
the unit to be controlled is controlled based on the control information received, and operates based on the attribute information input.

2. A control apparatus connected to a bus communicating a physical address, control information used for controlling, and a write request comprising:
(1) a controlling unit having a task program memory, an OS program memory, and a processing apparatus, wherein:
the task program memory is connected to the bus and stores plural task programs, each of which operates as a task;
the OS program memory is connected to the bus and stores an operating system program which manages plural access spaces for accessing an identical object to be controlled and operates as an operating system (OS) for making correspondence of the task with one or plural of the plural access spaces; and
the processing apparatus is connected to the bus and loads the operating system program, activates the operating system, loads the plural task programs, activates the task corresponding to the one or plural access spaces by the operating system, and transmits the physical address, the control information and the write request by an operation of the task;
(2) an attribute information identifying circuit connected to at least a part of the bus, wherein
the attribute information identifying circuit receives at least a part of the physical address from the bus, and outputs the attribute information specified by at least a part of the physical address received;
(3) a write control circuit connected to the bus, wherein
the write control circuit receives the physical address and the write request from the bus, and outputs a write control signal when a write instruction is detected based on the physical address and the write request received; and
(4) a unit to be controlled, which is the identical object to be controlled, connected to the bus, the write control circuit and the attribute information identifying circuit, wherein
the unit to be controlled inputs the write control signal, receives the control information from the bus when the write control signal is input, inputs the attribute information output from the attribute information identifying circuit, and
the unit to be controlled is controlled by the control information received and operates based on the attribute information input.

3. The control apparatus according to claim 2, wherein the operating system limits the physical address which is transferred to the bus from the processing apparatus based on the operation of the task within the one or plural access spaces corresponding to the task.

4. The control apparatus according to claim 2, wherein the operating system manages plural sets of the identical object to be controlled and the plural access spaces for accessing the identical object to be controlled.

5. The control apparatus according to claim 1, wherein the unit to be controlled comprises a control information memory, an attribute information memory, and a circuit to be controlled, wherein
the control information memory is connected to the bus and the write control circuit, inputs the write control signal, inputs the control information from the bus when the write control signal is input, and stores the control information input;
the attribute information memory is connected to the attribute information identifying circuit and the write control circuit, inputs the write control signal, inputs the attribute information output from the attribute information identifying circuit when the write control signal is input, and stores the attribute information input; and
the circuit to be controlled is connected to the control information memory and the attribute information memory and is controlled by the control information stored in the control information memory and operates based on the attribute information stored in the attribute information memory.

6. The control apparatus according to claim 2, wherein the unit to be controlled comprises a control information memory, an attribute information memory, and a circuit to be controlled, wherein
the control information memory is connected to the bus and the write control circuit, inputs the write control signal, inputs the control information from the bus when the write control signal is input, and stores the control information input;
the attribute information memory is connected to the attribute information identifying circuit and the write control circuit, inputs the write control signal, inputs the attribute information output from the attribute information identifying circuit when the write control signal is input, and stores the attribute information input; and
the circuit to be controlled is connected to the control information memory and the attribute information memory and is controlled by the control information stored in the control information memory and operates based on the attribute information stored in the attribute information memory.

7. The control apparatus according to claim 2, wherein the control information includes information capable to be dynamically changed by the operation of the task, and wherein the attribute information includes information which is predetermined before the operation of the task.

8. The control apparatus according to claim 2, wherein
the operating system manages OS management information, and
the attribute information includes a logically identical content with at least a part of the OS management information.

9. The control apparatus according to claim 5, wherein the control information memory comprises a control information queue and a control information register, and wherein:
the control information queue is connected to the bus and the write control circuit, inputs the control information when the write control signal is input, and stores the control information input;
the control information register inputs the control information stored in the control information queue, and stores the control information input; and
the control information queue inputs a next control information when the control information queue inputs a next write control signal before the circuit to be controlled completes an operation which is performed by inputting the control information stored in the control information register, and stores the next control information input, and
wherein the attribute information memory comprises an attribute information queue and an attribute information register, and wherein:
the attribute information queue is connected to the attribute information identifying circuit and the write control circuit, inputs the attribute information when the write control signal is input, and stores the attribute information input;
the attribute information register inputs the attribute information stored in the attribute information queue and stores the attribute information input; and
the attribute information queue inputs a next attribute information when the attribute information queue inputs a next write control signal before the circuit to be controlled completes an operation which is performed by inputting the attribute information stored in the attribute information register, and stores the next attribute information input.

10. The control apparatus according to claim 6, wherein the control information memory comprises a control information queue and a control information register, and wherein:
the control information queue is connected to the bus and the write control circuit, inputs the control information when the write control signal is input, and stores the control information input;
the control information register inputs the control information stored in the control information queue, and stores the control information input; and
the control information queue inputs a next control information when the control information queue inputs a next write control signal before the circuit to be controlled completes an operation which is performed by inputting the control information stored in the control information register, and stores the next control information input, and
wherein the attribute information memory comprises an attribute information queue and an attribute information register, and wherein:
the attribute information queue is connected to the attribute information identifying circuit and the write control circuit, inputs the attribute information when the write control signal is input, and stores the attribute information input;
the attribute information register inputs the attribute information stored in the attribute information queue and stores the attribute information input; and
the attribute information queue inputs a next attribute information when the attribute information queue inputs a next write control signal before the circuit to be controlled completes an operation which is performed by inputting the attribute information stored in the attribute information register, and stores the next attribute information input.

11. The control apparatus according to claim 1 further comprises a send data memory for storing send data; and
wherein the unit to be controlled comprises a data transferring circuit for inputting the send data from the send data memory, and transferring the send data to other elements.

12. The control apparatus according to claim 2 further comprises a send data memory for storing send data; and
wherein the unit to be controlled comprises a data transferring circuit for inputting the send data from the send data memory, and transferring the send data to other elements.

13. The control apparatus according to claim 11, wherein the attribute information includes information relating the send data.

14. The control apparatus according to claim 12, wherein the attribute information includes information relating the send data.

15. The control apparatus according to claim 1 further comprising a controlling unit connected to the bus and for transferring the physical address, the control information and the write request, and
wherein the controlling unit controls the unit to be controlled by once transferring a set of the physical address, the control information and the write request.

16. The control apparatus according to claim 2, wherein the controlling unit controls the unit to be controlled by once transferring a set of the physical address, the control information and the write request.

17. The control apparatus according to claim 1 further comprising a first access information input queue and a second access information input queue, and wherein
the attribute information identifying circuit is connected to at least a part of the bus via the first access information input queue, and receives at least a part of the physical address from the bus via the first access information input queue;
the write control circuit is connected to the bus via the first access information input queue, and receives the physical address and the write request from the bus via the first access information input queue; and
the unit to be controlled is connected to the bus via the second access information input queue, and receives the control information from the bus via the second access information input queue.

18. The control apparatus according to claim 2 further comprising a first access information input queue and a second access information input queue, and wherein
the attribute information identifying circuit is connected to at least a part of the bus via the first access information input queue, and receives at least a part of the physical address from the bus via the first access information input queue;
the write control circuit is connected to the bus via the first access information input queue, and receives the physical address and the write request from the bus via the first access information input queue; and
the unit to be controlled is connected to the bus via the second access information input queue, and receives the control information from the bus via the second access information input queue.

19. A method for controlling a control apparatus connected to a bus communicating a physical address, control information used for control, and a write request and having
an attribute information identifying circuit connected to at least a part of the bus and including plural attribute entries, each of which stores attribute information,
a write control circuit connected to the bus, and
a unit to be controlled connected to the bus, the write control circuit, and the attribute information identifying circuit, the method comprising:
(1) receiving at least a part of the physical address from the bus, specifying one attribute entry from the plural attribute entries based on the at least a part of the physical address received, and outputting the attribute information stored in the one attribute entry specified above by the attribute information identifying circuit;
(2) receiving the physical address and the write request from the bus, and outputting a write control signal when a write instruction is detected based on the physical address and the write request received by the write control circuit; and
(3) inputting the write control signal, when the write control signal is input, receiving the control information from the bus, and inputting the attribute information output from the attribute information identifying circuit, and
being controlled based on the control information received, and operating based on the attribute information input by the unit to be controlled.

20. A method for controlling a control apparatus connected to a bus communicating a physical address, control information used for controlling, and a write request having:
a task program memory connected to the bus and storing plural task programs, each of which operates as a task;
an OS program memory connected to the bus and storing an operating system program which manages plural access spaces for accessing an identical object to be controlled and operates as an operating system (OS) for making a correspondence of the task with one or plural of the plural access spaces;
a processing apparatus connected to the bus;
an attribute information identifying circuit connected to at least a part of the bus;
a write control circuit connected to the bus; and
a unit to be controlled, which is the identical object to be controlled, connected to the bus, the write control circuit and the attribute information identifying circuit, the method comprising:
(1) loading the operating system program, activating the operating system, loading the plural task programs, activating the task corresponding to the one or plural of the plural access spaces by the operating system, and transferring the physical address, the control information and the write request by the processing apparatus;
(2) receiving at least a part of the physical address from the bus, and outputting the attribute information specified by at least a part of the physical address received by the attribute information identifying circuit;
(3) receiving the physical address and the write request from the bus, and outputting a write control signal when a write instruction is detected based on the physical address and the write request by the write control circuit; and
(4) inputting the write control signal, receiving the control information from the bus when the write control signal is input, and inputting the attribute information output from the attribute information identifying circuit, and
being controlled by the control information received and operating based on the attribute information input by the unit to be controlled.
